(19) United States
(12) Patent Application Publication
(10) Pub. No.: US 2014/0000139 A1
(43) Pub. Date: Jan. 2, 2014

(54) Systems and Methods for displaying personalized photographs

(71) Applicant: Craig Donald Wieland, Mason, MI (US)

(72) Inventor: Craig Donald Wieland, Mason, MI (US)

(21) Appl. No.: 13/507,440

(22) Filed: Jun. 29, 2012

(51) Int. Cl. A47G 1/06; F21V 21/14; B23P 17/04; F21V 1/00

(52) U.S. Cl. 40/715; 362/311.01; 362/269; 362/351; 29/592

(57) ABSTRACT

The present embodiments relate to displaying personalized photographs. In certain embodiments, a photograph display system is provided. The photograph display system may include a base that is coupled with a personalized light shade. The personalized light shade may include one or more personalized photographs. The photograph display system may also include a light source coupled with an electrical connector. The light source may be positioned inside of the personalized light shade such that the light source is capable of illuminating the personalized light shade when connected to the electrical connector.

### BACKGROUND

The present embodiments relate to displaying personalized photographs.

There are many ways to display photographs. For example, photographs were originally printed on photograph paper. The photograph paper was then displayed in a desired location. Some typical display techniques for photograph paper included placing the photograph paper in a frame with glass on the front, taping the photograph paper to a wall, or using a pushpin to secure the photograph paper to a billboard, for example.

As the digital age has progressed, individuals have transitioned to displaying photographs using digital data. This has made it easier to personalize the display of photographs. For example, photographs can be uploaded to an electronic frame that displays the digital photograph. These electronic frames can be connected to the Internet and photographs streamed to the frame. Using a computing device, such as a personal computer or mobile device, individuals are then able to select and update the photographs that are displayed.

Individuals are always looking for new ways to display personalized photographs. Accordingly, there is a need for new ways of displaying photographs.

### BRIEF DESCRIPTION OF THE DRAWINGS

Certain embodiments are disclosed with reference to the following drawings.

FIG. 1 illustrates an exemplary embodiment of a system for displaying personalized photographs.

FIG. 2 illustrates an exemplary embodiment of a personalized light shade.

FIG. 3 illustrates another exemplary embodiment of a personalized light shade.

FIG. 4 illustrates a block diagram of a method of manufacturing a personalized light shade.

FIG. 5 illustrates a block diagram of a method of ordering a personalized light shade.

FIG. 6 illustrates an exemplary online website that allows ordering a personalized light shade.

Certain embodiments will be better understood when read in conjunction with the provided drawings, which illustrate examples. It should be understood, however, that the embodiments are not limited to the arrangements and instrumentality shown in the attached drawings.

### DESCRIPTION

The present embodiments relate to displaying one or more photographs. Certain embodiments relate to a photograph display system including a personalized light shade. Personal photographs are printed on the personalized light shade which may be backlit by a light source. The light source provides an appealing illumination of the photographs. The personalized nature of the shade makes it especially desirable because it allows personalized photographs to be displayed with an appealing display.

Certain embodiments relate to a photograph display system including a personalized light shade. In addition to the personal photographs, which are printed on the shade, the personalized light shade may include non-personal photographs. The non-personal photographs may relate to themes (e.g., baseball or dancing or landscapes).

Certain embodiments relate to a photograph display system. The photograph display system may include a base, a personalized light shade coupled to the base, a light source, and a electrical connector coupled to the light source. The personalized light shade may include one or more personalized photographs. The light source is positioned inside of the personalized light shade such that the light source is capable of illuminating the personalized light shade when connected to the electrical connector.

Certain embodiments relate to a method of manufacturing personalized light shades. The method may include receiving on or more personalized photographs of a user, printing the one or more personalized photographs on a light shade, and adapting the light shade to fit around a light source.

Certain embodiments relate to a personalized light shade. The personalized light shade may include a light shade with personalized photographs printed thereon. The personalized photographs are photographs that are not available to the public in general and are owned by an individual.

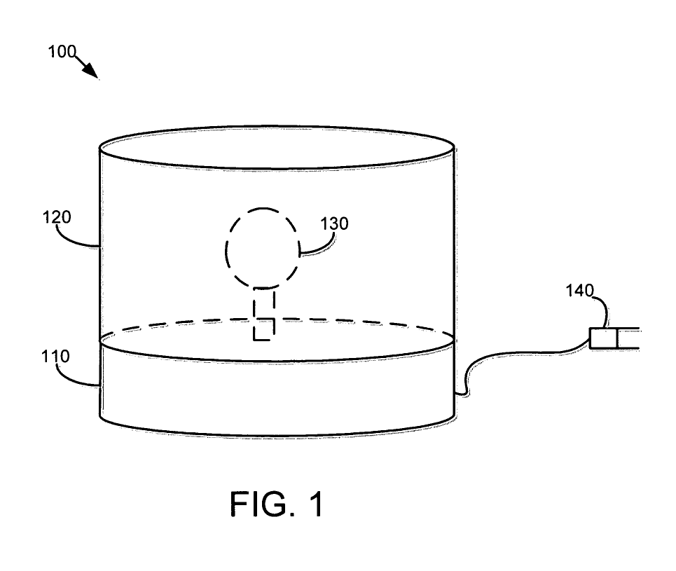

FIG. 1 illustrates a photograph display system 100 for displaying personalized photographs. The photograph display system 100 includes a base 110, personalized light shade 120, light source 130, and an electrical connector 140. Additional, different, or fewer components may be included. The base 110 may be coupled with the personalized light shade 120. The light source 130 may be coupled with the electrical connector 140. As used herein, the term “coupled with” includes directly connected or indirectly connected through one or more intermediary components.

The photograph display system 100 is a system that allows personalized photographs to be illuminated. The illumination of the photographs is appealing because it draws attention to one or more features of the photographs.

The base 110 may be a stationary base or a moving base. A stationary base is a base that is not intended to move (e.g., rotate, rock, swivel, tilt, etc.). For example, the stationary base may include a circular base that does not move. The circular base remains in a single location unless it is picked up and moved to a different location. As another example, the stationary base may include one or more legs (e.g., a tripod). In certain embodiments, although the base 110 may be stationary, the personalized light shade 120 may still move.

A moving base is a base that moves (e.g., rotates, rocks, tilts, etc.). Movement of the base 110 may move the personalized light shade 120. For example, the base 110 may be a rotating base that is coupled to the personalized light shade 120. As the base 110 rotates, the personalized light shade 120 rotates. In certain embodiments, the rotating base includes a “lazy susan” structure that allows the base 110 to rotate.

In certain embodiments, the photograph display system 100 may include an electronic motor that provides movement to the base 110. For example, the electronic connector 140, when connected to a power outlet, may provide power to a motor that rotates the base 110. The motor may be located in the base 110 and rotate the base 110 at various speeds.

The personalized light shade 120 may be a light shade that includes personalized photographs. The personalized photographs may be printed on the light shade in a way that illuminates the personalized photographs in an appealing way. For example, the light source may illuminate the personalized photographs so that the faces of the photographs are highlighted. In another example, the light source may illuminate the personalized photographs so snow-capped mountains are brighter that other portions of the photographs.

Personalized photographs are photographs that are not available to the public in general. Personalized photographs may be available to (e.g., owned, captured, or received by) the person purchasing the personalized light shade. For example, a grandma may use a digital camera to capture photographs of her grandchildren. The grandma may order a personalized light shade. The photographs of her grandchildren are personalized photographs with respect to the grandma. In another example, a mother may take photographs of her daughter using a camera (e.g., in her cell phone) and send the photographs to her husband (i.e., the father) via email or SMS. The father may order a personalized light shade. The photographs may be personalized photographs with respect to the mother or father.

In certain embodiments, the personalized light shade 120 may include only personalized photographs.

In certain embodiments, the personalized light shade 120 may include non-personalized photographs. Non-personalized photographs are photographs that are available to the public in general. For example, the seller of the personalized light shade 120 may make certain photographs available to anyone purchasing a personalized light shade 120. Non-personalized photographs may include themed photographs (e.g., fishing, camping, baseball, princess, romance themed photographs) that are available to purchasers.

In certain embodiments, the personalized light shade 120 is made of, for example, paper, clear or opaque thin plastic, lamination, photograph paper, cardboard, cloth, or other material on which photographs may be printed.

In certain embodiments, the photograph display system 100 includes a frame. The frame may be coupled to the base 110 and/or the personalized light shade 120. The personalized light shade 120 may be snapped onto the frame, for example. Accordingly, in certain embodiments, the personalized light shade 120 is replaceable. For example, the personalized light shade 120 may be changed.

The light source 130 may include an incandescent light, fluorescent light, or light emitting diode (LED) light, for example. The light source 130 may be coupled with and receive power from the electronic connector 140.

The light source 130 may include an on/off switch. The on/off switch may be configured to allow the light source to be turned on and off, even when the electronic connector 140 is electrically connected to a power source.

The light source 130 may include a dimmer switch. The dimmer switch may be configured to allow the light source to be dimmed, and potentially even turned on and off, when the electronic connector 140 is electrically connected to a power source.

The electrical connector 140 may connect to a power source, such as an electrical outlet (e.g., 120 volts) or a battery. The power source may provide power to the photograph display system 100. For example, the power source may provide power to the light source 130 or a motor that rotates the base.

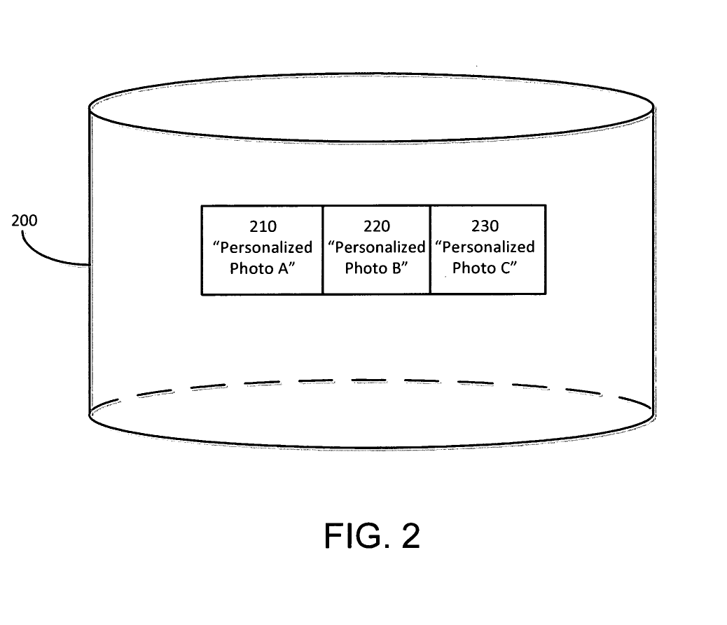

FIG. 2 illustrates an example of a personalized light shade 200, which may be similar to the personalized light shade 100 of FIG. 1. As shown in FIG. 2, the personalized light shade 200 may include personalized photographs 210-230. In certain embodiments, the personalized light shade 200 may include additional, different, or fewer personalized photographs.

The personalized photographs 210-230 may be displayed on the personalized light shade 200. This may involve printing, inscribing, or otherwise making visible the personalized photographs 210-230 on the personalized light shade 200.

The layout of the personalized photographs 210-230 may vary. For example, as shown in FIG. 2, the personalized photographs 210-230 may be displayed adjacent to each other. In other embodiments, personalized photographs 210-230 may be displayed at other locations and not necessarily right next to each other. For example, personalized photograph 210 may be displayed at the top of the personalized light shade 200 and the other personalized photographs 220, 230 may be displayed at the bottom. There may be a gap between the photographs.

In certain embodiments, as shown in FIG. 2, there is no overlap of the personalized photographs 210-230. However, in certain embodiments, there is overlap of at least some of the personalized photographs 210-230. For example, in certain embodiments, a personalized photograph, such as photograph 210, may be used as a backdrop for the other photographs 220-230.

In certain embodiments, only a portion of one or more of the personalized photographs 210-230 is displayed on the personalized light shade 200.

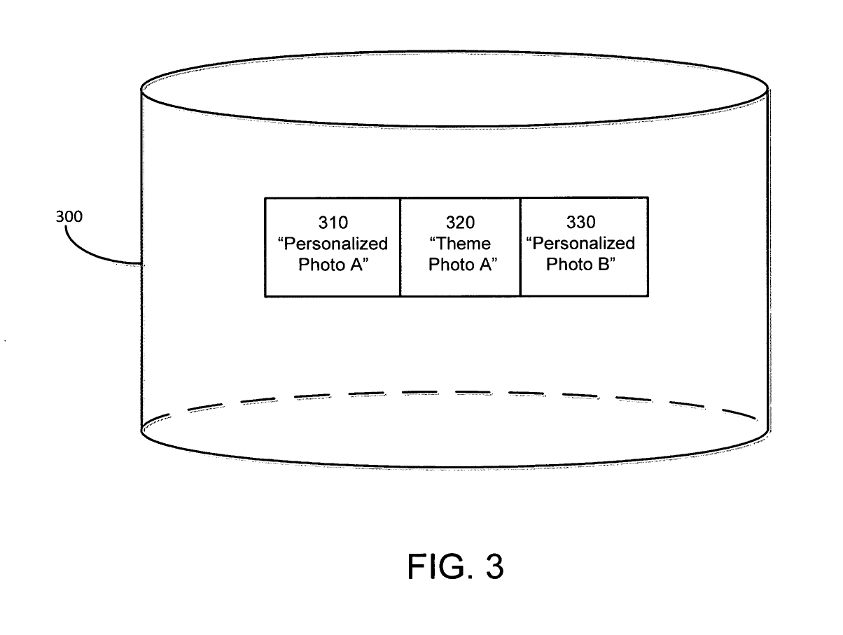

FIG. 3 illustrates another example of a personalized light shade 300, which may be similar to the personalized light shade 100 of FIG. 1 and/or the personalized light shade 200 of FIG. 2. In addition to personalized photographs 310 and 330, the personalized light shade 300 includes a non-personalized photograph 320. The difference between FIG. 2 and FIG. 3 is that FIG. 2 includes only personalized photographs and FIG. 3 includes both personalized photographs and non-personalized photographs.

The personalized light shade 300 may include additional, different, or fewer photographs. For example, the personalized light shade 300 may include additional personalized photographs and/or non-personalized photographs.

As shown in FIG. 3, the non-personalized photograph 320 is a themed photograph. However, it does not have to be a themed photograph. Instead, it may be a randomly selected photograph that does not relate to a theme. For example, it may be selected because of its visually appealing nature.

The photographs 310-330 may be displayed on the personalized light shade 300. This may involve printing, inscribing, or otherwise making visible the photographs 310-330 on the personalized light shade 200.

The non-personalized photograph 320 may be selected for various reasons. In certain embodiment, the non-personalized may be selected because of a particular theme. For example, the personalized photographs 310, 330 may be of a father/son fishing trip, so the non-personalized photograph 320 may be of a fish or fishing scene. Non-personalized photographs may be stock photographs or filler photographs.

The layout of the photographs 310-330 may vary. For example, as shown in FIG. 3, the photographs 310-330 may be displayed adjacent to each other. In other embodiments, the photographs 310-330 may be displayed at other locations and not necessarily right next to each other. For example, personalized photograph 210 may be displayed at the top of the personalized light shade 200 and the other personalized photographs 220, 230 may be displayed at the bottom. There may be a gap between the photographs.

In certain embodiments, as shown in FIG. 3, there is no overlap of the photographs 310-330. However, in certain embodiments, there is overlap of at least some of the photographs 310-330. For example, in certain embodiments, a personalized photograph or a non-personalized photograph may be used as a backdrop for the other photographs.

In certain embodiments, only a portion of one or more of the personalized photographs 210-230 is displayed on the personalized light shade 200.

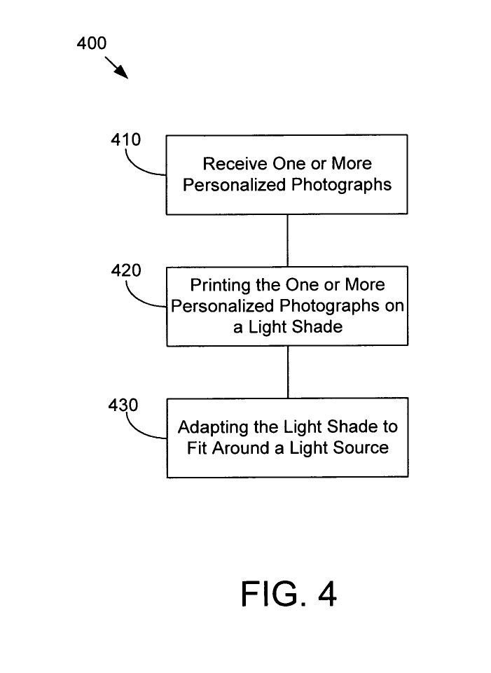

FIG. 4 illustrates an embodiment of a method 400 of manufacturing a personalized light shade. As shown in FIG. 4, the method 400 includes receiving one or more personalized photographs of a user 410, printing the one or more personalized photographs on a light shade 420, and adapting the light shade to fit around a light source 430. The method may include additional, different, or fewer acts.

In act 410, one or more personalized photographs are received. The personalized photographs may be received via the Internet, electronic mail, postal mail, or a different network. Act 410 may include providing a potential customer the ability to upload one or more personalized photographs.

In act 420, the one or more personalized are printed on a light shade. Printing may include displaying the personalized photographs on the light shade. In some embodiments, the photographs are printed prior to the light shade being formed into a shade shape. For example, the photographs may be printed while the shade is flat and

In act 430, the shade may be adapted to fit onto the base. Adapting may include rolling the light shade into a cylinder. The cylinder may be adapted to fit onto the base. In certain embodiments, adapting includes connecting the light shade to a frame that is adapted to connect to a base.

The method 400 may include shipping the personalized light shade to a customer that provides payment for the personalized light shade.

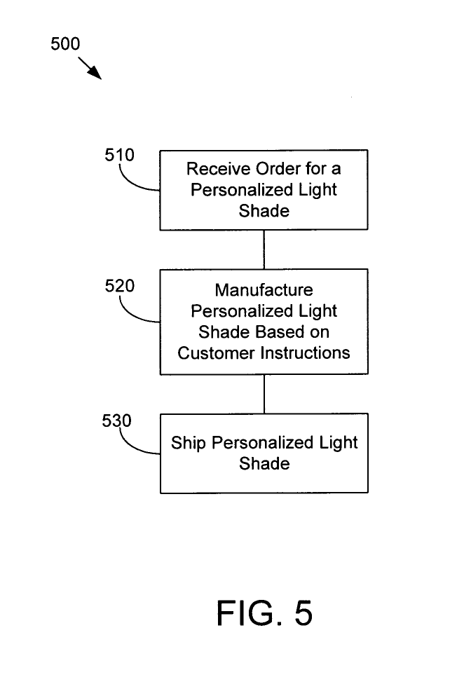

FIG. 5 illustrates an embodiment of a method of distributing a personalized light shade. The method may include additional, different, or fewer acts. In act 510, an order for a personalized light shade is received from a customer. The order may include specific instructions, such as what personalized photographs to use, the layout, and so on. In act 520, the personalized light shade is manufactured. In act 530, the personalized light shade, which is customized to the customer's instructions, is shipped to the customer.

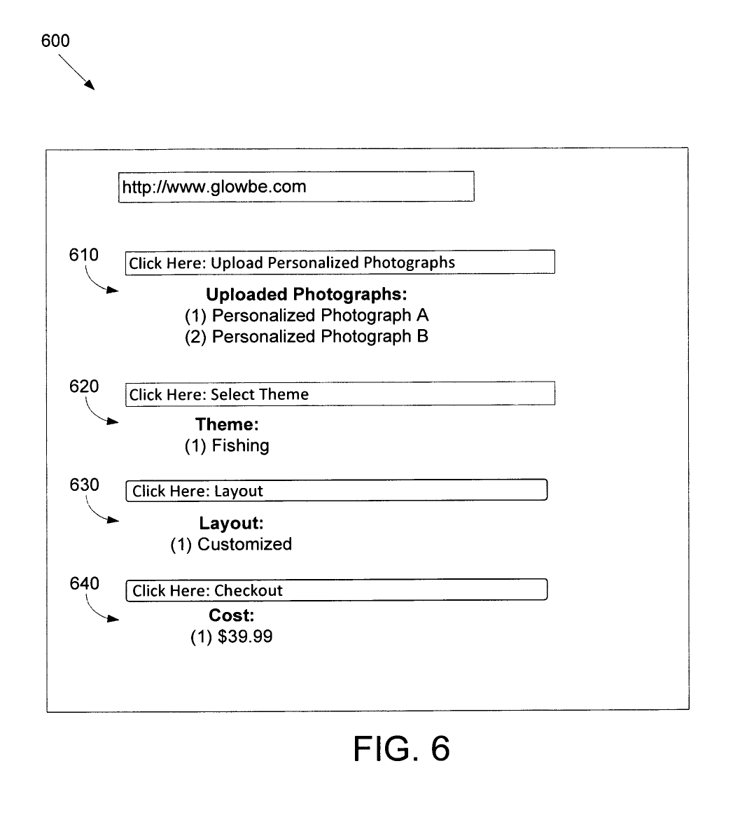

FIG. 6 illustrates an embodiment of an online website that allows a consumer to order a personalized light shade. The online website 600 may include a photograph button 610, theme button 620, layout button 630, and a check-out button 640. While FIG. 6 illustrates an example of allowing a customer to purchase a personalized light shade, the actual layout, structure, and/or content may vary. The online website 600 may include additional, different, or fewer components.

The photograph button 610 may be configured to allow a potential customer to upload one or more personalized photographs. Once uploaded, as shown in FIG. 6, the personalized photographs may be included in a summary list. Or, in certain embodiments, the actual photograph may be displayed.

The theme button 620 may be configured to allow a potential customer to select a theme. Various themes may be shown in a drop-down menu, for example. Once a theme is selected, as shown in FIG. 6, the theme may be shown on the website 600. In FIG. 6, a fishing theme was selected. The non-personalized photographs, which are associated with the theme, may also be displayed or included in a summary list.

In certain embodiments, non-personalized photographs, which are not part of a theme, may be selected by potential customer.

The layout button 630 may be configured to allow a potential customer to customize the layout. In the event that the potential customer chooses to customize the layout, the online website may display an illustration of the personalized light shade and allow the potential customer to personally select the layout. For example, in certain embodiments, the potential customer may personally select where photographs are placed in a template.

In certain embodiments, the potential customer may choose to have a standard layout. A standard layout is a layout that is automatically selected; not by the potential customer. The standard layout may be selected based on the personalized photographs uploaded, for example, to provide the most appealing layout. In other embodiments, the various photographs are automatically fed into a template, without any input from the potential customer.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

Some of the described figures depict example block diagrams, systems and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, or any combination thereof, for example.

The example block diagrams, systems, and/or flow diagrams may be implemented using any combination(s) of application specific integrated circuit(s) (“ASIC”(s)), programmable logic device(s) (“PLD”(s)), field programmable logic device(s) (“FPLD”(s)), discrete logic, hardware, and/or firmware, for example. Also, some or all of the example methods may be implemented manually or in combination with the foregoing techniques, for example.

Further, although the example block diagrams, systems, and/or flow diagrams are described above with reference to the figures, other implementations may be employed. For example, the order of execution of the components, elements, blocks and/or other functionality may be changed, and/or some of the components, elements, blocks and/or other functionality described may be changed, eliminated, sub-divided, or combined. Additionally, any or all of the components, elements, blocks, and/or other functionality may be performed sequentially and/or in parallel by, for example, separate processing threads, processors, devices, discrete logic, and/or circuits.

1. A photograph display system comprising:
a base;
a personalized light shade coupled to the base, wherein the personalized light shade includes one or more personalized photographs;
a light source; and
a electrical connector coupled to the light source, wherein the light source is positioned inside of the personalized light shade such that the light source is capable of illuminating the personalized light shade when connected to the electrical connector.

2. The photograph display system of claim 1, wherein the base is a stationary base.

3. The photograph display system of claim 1, wherein the base is a moving base.

4. The photograph display system of claim 3, wherein the moving base rotates.

5. The photograph display system of claim 3, wherein the base includes a lazy susan structure.

6. The photograph display system of claim 1, wherein the light source includes a light bulb that is adapted to illuminate the personalized light shade.

7. The photograph display system of claim 1, wherein the personalized light shade includes one or more non-personalized photographs.

8. The photograph display system of claim 1, wherein

9. A method of manufacturing a personalized light shade:
receiving on or more personalized photographs of a user;
printing the one or more personalized photographs on a light shade; and
adapting the light shade to fit around a light source.

10. The method of claim 9, wherein receiving includes receiving over the Internet.

11. The method of claim 9, wherein receiving includes providing a potential customer the ability to upload one or more personalized photographs.

12. The method of claim 9, wherein printing includes displaying the personalized photographs on the light shade.

13. The method of claim 9, wherein adapting includes rolling the light shade into a cylinder.

14. The method of claim 13, wherein the cylinder is adapted to fit onto a base.

15. The method of claim 9, wherein adapting includes connecting the light shade to a frame that is adapted to connect to a base.

16. The method of claim 9, further comprising: shipping the personalized light shade to a customer that provides payment for the personalized light shade.

17. A personalized light shade comprising:
a light shade with personalized photographs printed on the light shade, wherein the personalized photographs are photographs that are not available to the public in general and are owned by an individual.

18. The personalized light shade of claim 17, wherein the personalized light shade includes a frame that is configured to connect to a base.

19. The personalized light shade of claim 18, wherein the base rotates.

20. The personalized light shade of claim 17, wherein the light shade includes non-personalized photographs that are generally available to any potential customer of personalized light shades.
